(19) United States
(12) Patent Application Publication
(10) Pub. No.: US 2010/0100659 A1
(43) Pub. Date: Apr. 22, 2010

(54) COMPUTER SYSTEM

(75) Inventors: YI-FANG WU, Tu-Cheng (TW); YONG-HUI XIAO, Shenzhen City (CN); ZHEN WANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/492,481

(22) Filed: Jun. 26, 2009

(30) Foreign Application Priority Data
Oct. 16, 2008 (CN) 200810304951.2

(51) Int. Cl. G06F 13/36

(52) U.S. Cl. 710/306

(57) ABSTRACT

A computer system includes hard disc, and a control circuit electrically connected to the hard disc. The control circuit includes a connecting port electrically connected to an external connecting port for transmitting data signals with another computer, a switch, a voltage converter, and a signal transforming controller. The switch includes a first terminal electrically connected to the connecting port, and a second terminal. The voltage converter includes an input terminal electrically connected to the connecting port for receiving an external voltage, and an output terminal for outputting a converted voltage. The signal transforming controller includes a first signal terminal electrically connected to the second terminal of the switch, a voltage input terminal electrically connected to the output terminal of the voltage converter, and a second signal terminal electrically connected to the hard disc.

### BACKGROUND

1. Technical Field

The present disclosure relates to a computer system, particularly to a computer system for accessing a hard disc of the computer system when the computer system is powered-off.

2. Description of Related Art

In information technology, backup of data between computers becomes very important and frequent. Conventionally, computers are connected by networks for data transmission, and may use an additional storage card to copy data from one computer to another. However, backup of data between computers becomes impossible when one of the computers is powered-off.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a computer system for accessing a hard disc of the computer system when the computer system is powered-off.

FIG. 2 is a circuit diagram of the computer system of FIG. 1.

### DETAILED DESCRIPTION

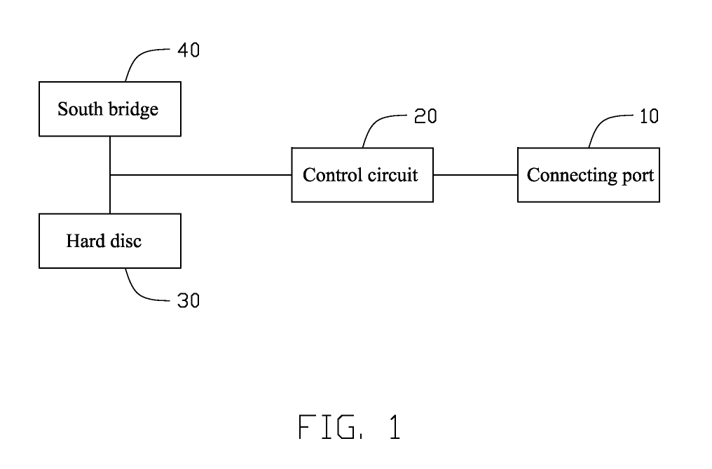

FIG. 1 is a block diagram of an embodiment of a computer system for accessing a hard disc of the computer system when the computer system is powered-off. The computer system includes a connecting port 10 electrically connected to an external connecting port (not shown) for data exchange with another computer (not shown), a control circuit 20, a hard disc 30, and a south bridge 40.

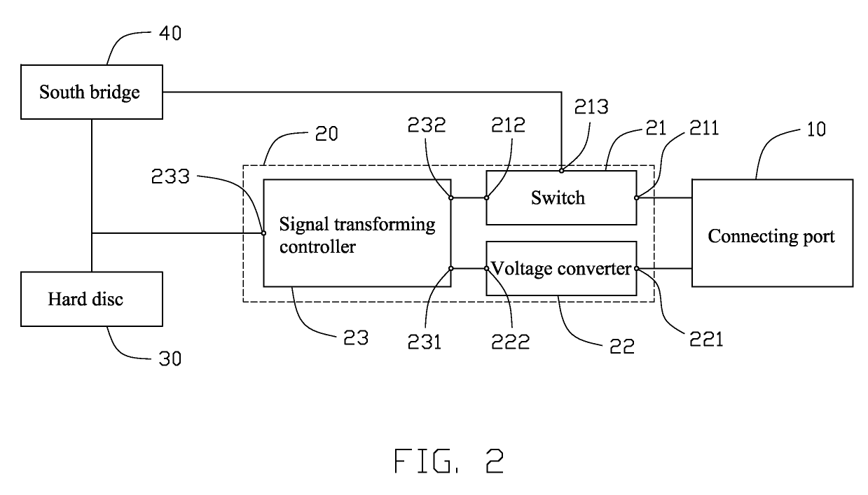

Referring to FIG. 2, the control circuit 20 includes a switch 21, a voltage converter 22, and a signal transforming controller 23. The voltage converter 22 includes an input terminal 221 electrically connected to the connecting port 10 for receiving an external voltage, and an output terminal 222 electrically connected to a voltage input terminal 231 of the signal transforming controller 23. The switch 21 includes a first terminal 211 electrically connected to the connecting port 10, a second terminal 212 electrically connected to a first signal terminal 232 of the signal transforming controller 23, and a third terminal 213 electrically connected to the south bridge 40. The signal transforming controller 23 further includes a second signal terminal 233 electrically connected to the hard disc 30.

In this embodiment, the connecting port 10 and the external connecting port are Universal Serial Bus (USB) ports. The external connecting port provides a 5 volt external voltage for the connecting port 10. The voltage converter 22 is a low dropout regulator (LDO) for converting the 5 volt external voltage to 3.3 volts, and providing the 3.3 volts as a work voltage to the signal transforming controller 23. The switch 21 is a relay for switching the connection of the connecting port 10 to either the signal transforming controller 23 or the south bridge 40. The signal transforming controller 23 is a USB to Serial Advanced Technology Attachment (SATA) controller for transforming USB signals from the switch 21 to SATA signals. The hard disc is a SATA hard disc.

In use, the external connecting port is connected to the connecting port 10. When the computer system is powered-on, the switch 21 closes the connection between the connecting port 10 and the south bridge 40, and opens the connection between the connecting port 10 and the signal transforming controller 23. The external connecting port is capable of accessing the hard disc 30 via the switch 10 and the south bridge 40. When the computer system is powered-off, the switch 21 closes the connection between the connecting port 10 and the signal transforming controller 23 and opens the connection between the connecting port 10 and the south bridge 40. The voltage converter 22 provides the 3.3 volt work voltage to the signal transforming controller 23. The external connecting port is capable of accessing the hard disc 30 via the switch 10 and the signal transforming controller 23.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer system comprising:
a hard disc; and
a control circuit electrically connected to the hard disc, the control circuit comprising:
a connecting port electrically connected to an external connecting port for transmitting data signals with another computer;
a switch comprising a first terminal electrically connected to the connecting port, and a second terminal;
a voltage converter comprising an input terminal electrically connected to the connecting port for receiving an external voltage, and an output terminal for outputting a converted voltage; and
a signal transforming controller with a first signal terminal electrically connected to the second terminal of the switch for transmitting data signals with the switch, a voltage input terminal electrically connected to the output terminal of the voltage converter for receiving the converted voltage, and a second signal terminal electrically connected to the hard disc for transmitting data signals with the hard disc.

2. The computer system of claim 1, wherein the switch further comprises a third terminal electrically connected to a south bridge for transmitting data signals with the south bridge.

3. The computer system of claim 1, wherein the connecting port is a Universal Serial Bus (USB) port.

4. The computer system of claim 2, wherein the switch is a relay, the relay closes the connection between the connecting port and the south bridge when the computer system is powered-on, and closes the connection between the connecting port and the signal transforming controller when the computer system is powered-off.

5. The computer system of claim 1, wherein the voltage converter is a low dropout regulator (LDO) for transforming a 5 volt voltage to a 3.3 volt voltage.

6. The computer system of claim 1, wherein the signal transforming controller is a USB to Serial Advanced Technology Attachment (SATA) controller for transforming USB signals to SATA signals.

7. The computer system of claim 1, wherein the hard disc is a SATA hard disc.
